(19) United States
(12) Patent Application Publication
(10) Pub. No.: US 2019/0322192 A1
(43) Pub. Date: Oct. 24, 2019

(54) Forklift Having An Integrated Battery Box

(71) Applicant: Zhejiang E-P Equipment Co., Ltd., Hangzhou (CN)

(72) Inventors: Jiang Zhongwei, Hangzhou (CN); Ma Qichen, Hangzhou (CN); Wang Zheng, Hangzhou (CN); Li Yang, Hangzhou (CN); Yu Xiaoxian, Hangzhou (CN)

(21) Appl. No.: 16/387,112

(22) Filed: Apr. 17, 2019

(30) Foreign Application Priority Data
Apr. 19, 2018 (CN) 201820564242.7

(51) Int. Cl. B60L 53/80; B60R 16/033; B66F 9/075

(52) U.S. Cl. CPC B60L 53/80; B60Y 2200/15; B66F 9/07572; B60R 16/033

(57) ABSTRACT

A forklift includes an integrated battery box. The forklift includes a forklift body having a mounting chamber with an opening to a side of the forklift body. The battery box is loaded into the mounting chamber from the side opening. After the battery box is loaded into the mounting chamber, a mechanical connection between the battery box and the forklift is realized by the locking mechanism, and a circuit connection between the battery box and an electric control mechanism of the forklift is realized by a plug-in device.

### CROSS-REFERENCE TO RELATED APPLICATION

This application claims priority to Chinese Patent Application No. 201820564242.7, filed Apr. 19, 2018, which is hereby incorporated by reference in its entirety.

### TECHNICAL FIELD

The invention relates to forklifts, and more particularly to a forklift suitable for small space operation and having an integrated battery box.

### BACKGROUND

Forklifts, also commonly referred to as forklift trucks, are industrial transport vehicles. The term forklift refers to numerous kinds of wheeled transport vehicles for loading, unloading, stacking and short-distance transportation of cargo on pallets.

Forklifts need to work in small spaces. For forklifts to operate flexibly and require smaller working space, it is necessary to reduce the volume of a traditional forklift. However, when the volume of a forklift is reduced, it may lead to a reduction of the driver's operating space and affect the operator's operating comfort. In addition, because of limited design space, the layout of a relatively compact, small forklift may be inconvenient for inspection and maintenance.

In addition, existing battery-powered forklifts generally use lead-acid batteries. Due to the large volume of lead-acid batteries, the batteries usually are located near the cockpit on the forklift and under the driver's seat. Because of this, the battery occupies a large space, resulting in a larger forklift volume, and battery replacement typically requires the help of lifting equipment, such as a crane, which is cumbersome and inconvenient.

As shown in FIG. 5, a forklift using the prior art existing technology generally relies mainly on mechanical steering and relies on hydraulic power steering. The steering mechanism is connected under the steering wheel through universal joints, which is presently the most widely used hydraulic steering connection structure. Turning the steering wheel eventually drives the steering gear to turn, which is directly assisted by a mechanical-hydraulic mode. Such a steering mode must rely on the power of the hydraulic pump motor, so the pump motor is working all the time. This is very wasteful in terms of energy consumption, and the torsion required to rotate the steering wheel is quite large, which causes workers who operate a forklift for a long time to become quite tired. An alternative has been to increase the use of electronic power steering with a separate electronic steering motor. However, the former has tended to consume too much energy and has provided poor maneuverability, while the latter is mostly used in single-drive three-pivot forklifts, due to the limitations of the mechanical structure.

### SUMMARY

The present disclosure addresses the above-mentioned problems with prior art forklifts by providing a forklift having an integrated battery box. The integrated battery box is small in size, and removably installed on a forklift. The battery box is electrically connected with the electric control mechanism of the forklift through a locking mechanism, and the battery box is easy to disassemble, assemble and replace.

In order to achieve the above advantages, an integral battery box of a forklift is provided with an mounting chamber for installing a battery box having a lithium battery, and an opening for plug-in or pull-out of the battery box on the left or right side of the installation chamber. When the battery box is loaded into the mounting chamber, on the one hand, a mechanical connection between the battery box and the forklift body is realized through a locking mechanism, on the other hand, the an electrical connection between the battery box and the forklift body is realized through the circuit connection between the battery box and the electric control mechanism of the forklift. The body of the battery box is provided with an external power supply socket, the position of the power supply socket is fixed on the battery box, and an electric interface is fixed on the forklift body. The electric interface has at least positive and negative contacts, which are connected in series e electric control mechanism of the forklift. The plug-in device has a power supply contact and an electric control contact. There are up and down dislocations or front and back dislocations between the electric control contact and the power supply contact in the plug-in direction of the plug-in device. The power supply contact mates with the power supply socket on the battery box, and the electric control contact mates with the electric interface on the forklift body.

A preferred embodiment includes a sliding guide device arranged between the battery box and the mounting chamber on the forklift. The sliding guide device includes a plurality of rollers arranged at the bottom of the mounting chamber, which are distributed on the moving route of the battery box relative to the mounting chamber. During the process of loading or removing the battery box, the bottom of the battery box contacts with a rolling plane of the rollers, and the sliding guide device also includes a guide rail guiding the battery box.

The locking mechanism of the preferred embodiment includes a locking bolt mounted on the battery box and a slot located on the forklift body, which receives the inserted locking bolt. The locking bolt can slide up and down relative to a socket, so as to insert the locking bolt into the slot or to remove the locking bolt from the slot. The locking mechanism also includes keeping the locking bolt in the slot or a positioning component that is removed from the slot.

In the preferred embodiment, a socket is arranged in and fixed relative to the battery box. The upper end of the socket always is exposed from the upper end of the battery box, and the lower end of the battery box is provided with an opening for the downward receipt of the socket, and the slot is located at the bottom of the mounting chamber on the forklift body. After fully mounting the battery box in the mounting chamber, the opening is aligned with the slot.

Also in the preferred embodiment, a positioning component includes a positioning post connected with the locking bolt and a positioning groove arranged on a battery box. Before the positioning post is inserted into the positioning groove, the positioning post is raised to keep the locking bolt out of the slot due to the limitation of the upper end face of the battery box, the positioning post is rotated to the positioning groove and the positioning post is pushed downward. The driving locking bolt is clamped into the slot.

In the preferred embodiment, a plug-in device is equipped with a handle. Contacts are connected in series in the connection circuit between the plug-in device and the electronic control mechanism.

Also in the preferred embodiment, there is a step on the battery box to facilitate ingress and egress to the cockpit of the forklift.

### DESCRIPTION OF THE DRAWINGS

FIG. 1 is a schematic diagram of a forklift in accordance with the present disclosure.

FIG. 2 is a schematic diagram of the opposed side of the forklift of FIG. 1.

FIG. 3 is a layout diagram of components on the forklift body of the forklift of FIGS. 1-2.

FIG. 4 is a schematic diagram of the connection structure of the driving mechanism of the forklift of FIGS. 1-2.

FIG. 5 is a block diagram of the principle of forklift steering in the prior art.

FIG. 6 is a schematic diagram of the connection structure of the hydraulic power steering the forklift of FIGS. 1-2.

FIG. 7 is a block diagram of the hydraulic power steering of the forklift of FIGS. 1-2.

FIG. 8 shows the structure of the battery box and the plug-in of the forklift of FIGS. 1-2.

FIG. 9 is a schematic diagram of the locking mechanism of the forklift of FIGS. 1-2.

FIG. 10 is a schematic diagram of a plug-in connection between the battery box and the electronic control part of the forklift of FIGS. 1-2.

FIG. 11 shows the mounting chamber of the forklift body and upper and lower counterweights of the forklift truck of FIGS. 1-2.

FIG. 12 shows an enlargement of the area D in FIG. 11.

A list of structures and features identified within the application drawings and discussed herein includes: forklift body 1, partition 11, mounting chamber 12, rollers 121, slot 122, upper weight 13, lower weight 14, rear panel 15, seat bracket 16, lifting mechanism 2, lifting frame 21, fork 22, safety cage 3, cockpit 4, seat 41, control mechanism 42, steering wheel 421, driving mechanism 5, driving wheel 51, driving gearbox 52, driving motor 53, electromagnetic brake 54, steering mechanism 6, steering bridge 61, steering wheel 62, steering potentiometer 63, EPS motor 64, EPS controller 65, electronic control mechanism 7, lithium battery box 71, step 711, locking bolt 712, socket 713, copper sleeve 714, positioning post 715, handle 716, controller 72, plug-in device 73, power supply contacts 731, electric control contacts 732, connecting cable 74, contactor power switch 75, hydraulic mechanism 8, tank 81, solenoid valve 82, gear pump 83, pump motor 84, tank filling port 85, hydraulic supply system 86.

### DETAILED DESCRIPTION OF THE PREFERRED EMBODIMENT

An embodiment of a forklift is described in detail below, and an example of the embodiment is shown in the drawings in which identical or similar labels throughout represent identical or similar elements, or elements with the same or similar functions. The following embodiments described with reference to the drawings are illustrative and are intended to be used to explain, rather than to limit the disclosure.

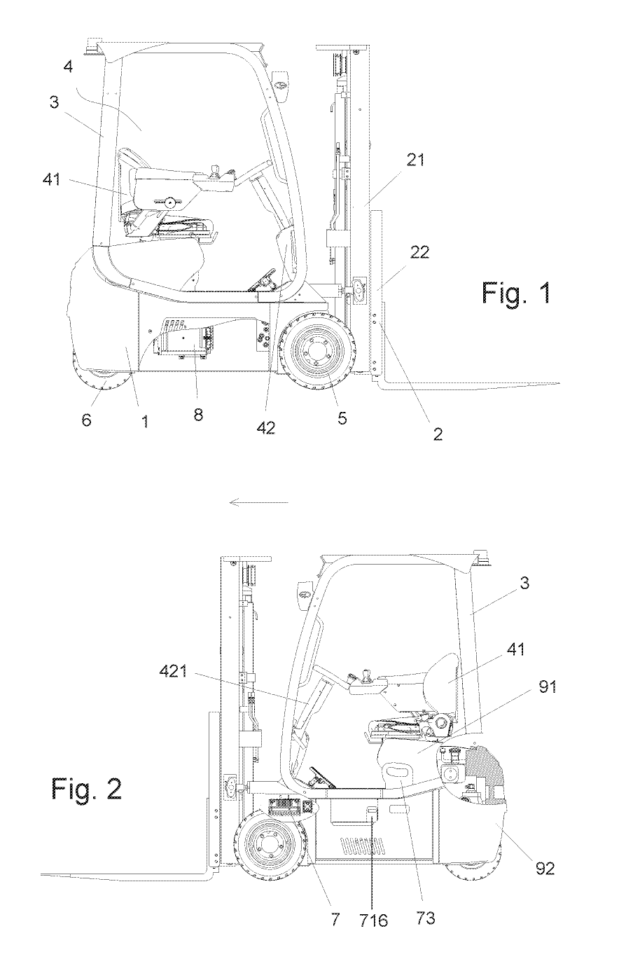

A forklift shown in FIGS. 1 and 2 includes a forklift body 1, with a lifting mechanism 2 on the front side of the body 1. The lifting mechanism 2 includes a lifting frame 21 and a lifting fork 22 on the lifting frame 21. An operator's cockpit 4 is located above the body 1, and includes a seat 41 connected to the body 1 and a control mechanism 42 in the cockpit 4. In this embodiment, the outer side of the cockpit is provided with a safety cage 3, which is fixed above the body 1. The lower part of body 1 is equipped with a driving mechanism 5, steering mechanism 6, electronic control mechanism 7 and hydraulic mechanism 8.

This example forklift, which also may be referred to as a lithium battery forklift, is driven by two front wheels and steered by two rear wheels that are located side-by-side. A three-fulcrum forklift is a forklift with three supporting points to support the weight of the whole forklift. The three supporting points include two supporting points composed of two spaced apart front wheels and the one supporting point which includes the side-by-side rear wheels located laterally in the middle of the rear of the forklift. The three-pivot forklift has similar stability relative to a four-pivot forklift truck, but the steering of the three-pivot forklift truck is more flexible, in the sense of an ability to provide a small turning radius, especially when turning 360 degrees in a small space. Also, the dual front wheel drive provides strong power, traction and climbing ability.

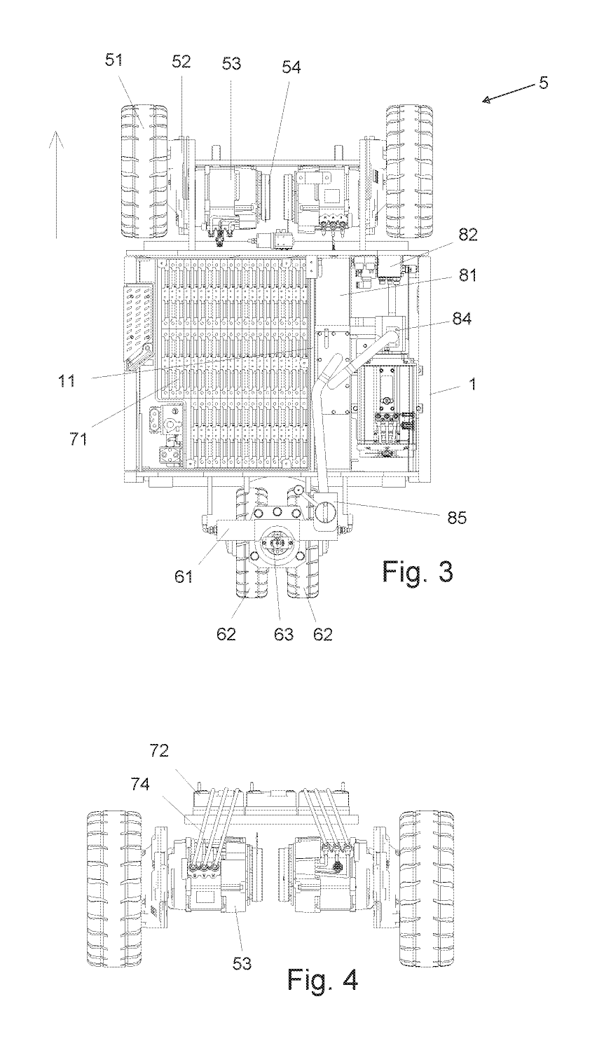

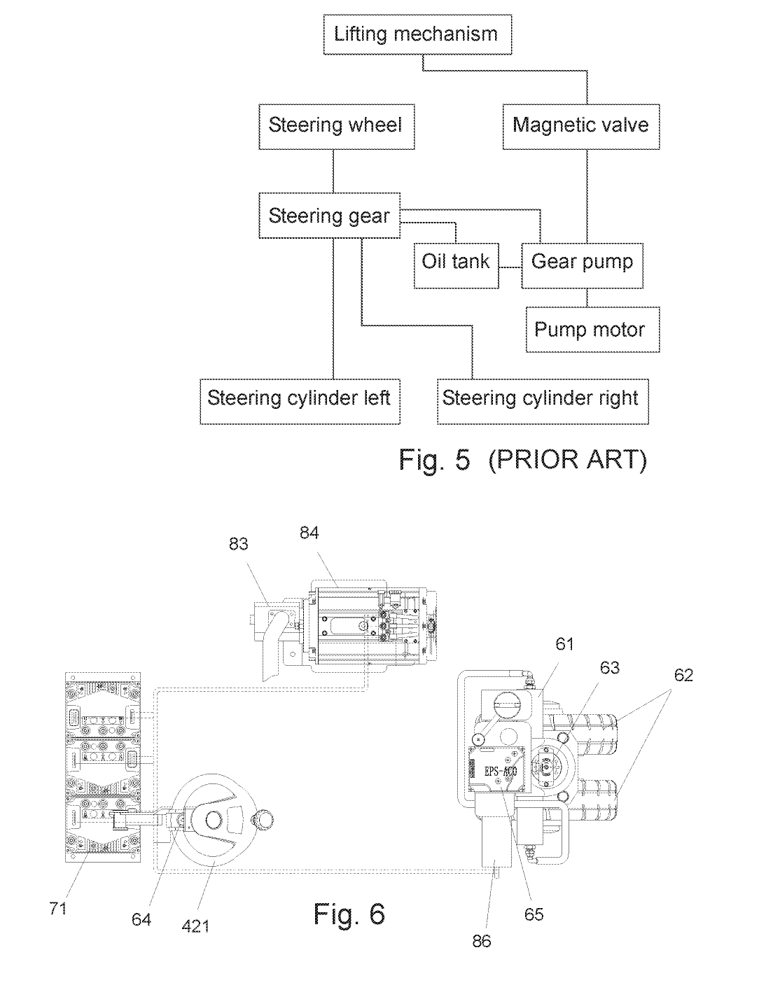

As shown in FIG. 3, the driving mechanism 5 is installed in the front of the forklift body 1. The driving mechanism includes the driving wheels 51, the driving gearbox 52 connected with the two driving wheels 5 he driving motor 53 and the electromagnetic brake 54, respectively. The output shaft of the driving motor 53 is connected with the electromagnetic brake 54 and the driving gearbox 52, and the driving gearbox 52 is connected with the driving wheels 51. The control mechanism 42 is electrically connected with the electromagnetic brake 54. The forklift adopts an electronic booster brake, which has stable performance and is safe and reliable.

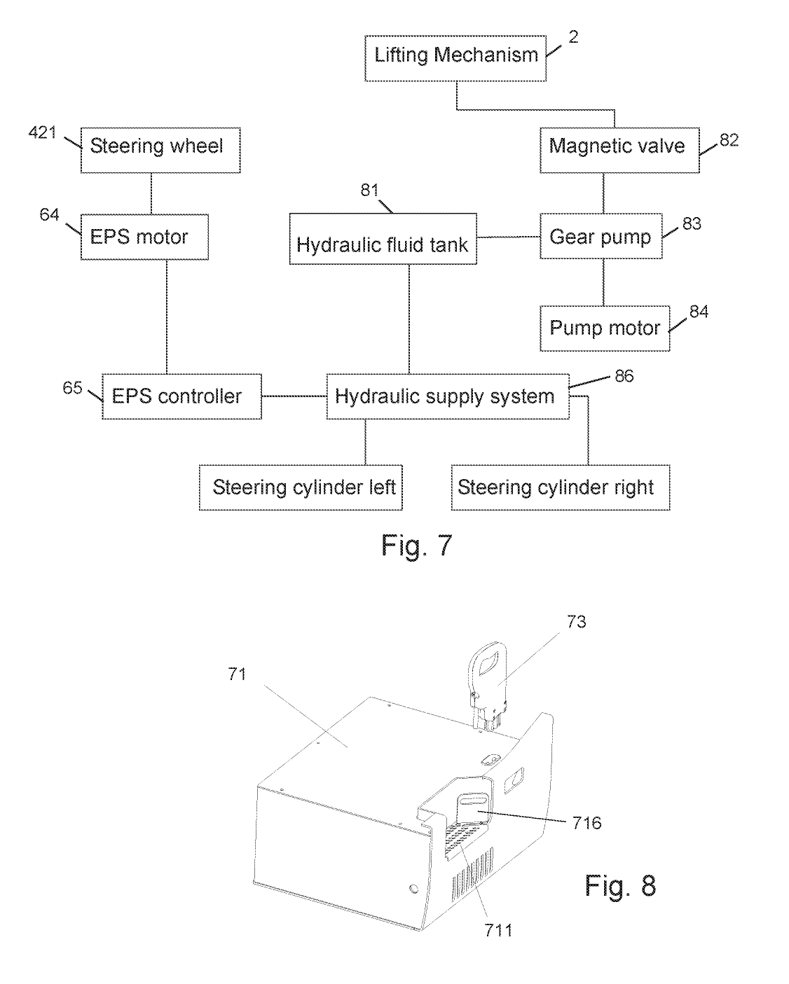

As shown in FIGS. 3, 6 and 7, the steering mechanism 6 is used to realize the steering function of the forklift. The steering mechanism 6 includes a steering bridge 61, two steering wheels 62 and steering potentiometer 63. The steering bridge 61 is installed laterally in the middle of the rear of the forklift body 1. Under the action of a steering cylinder, the steering bridge 61 can rotate clockwise or counterclockwise. The left and right hydraulic ports of the steering cylinder are connected to the hydraulic mechanism 8, respectively, and the steering axle 61 accordingly is driven by the hydraulic mechanism 8. The two rotating wheels 62 are installed side-by-side on the steering bridge 61, and the rotation of the steering bridge 61 drives the rotating wheels 62 to rotate together. The steering potentiometer 63 is installed on the upper end of the steering bridge 61. The steering potentiometer 63 is connected with the electronic control mechanism 7. The steering wheel's rotation angle is monitored in real time. When the steering potentiometer 63 collects the steering wheel direction relative to a fixed angle, the angle signal is transmitted to the electronic control mechanism 7. The electronic control mechanism 7 limits the control of hydraulic mechanism 8 overflow, so that the steering wheel 62 cannot oversteer. Generally speaking, the established maximum angle is 90 degrees. At the same time, the electronic control mechanism 7 can also adjust the speed of the forklift after receiving the angle signal, which has achieved the function of turning and decelerating.

The hydraulic mechanism 8 is divided into a lifting hydraulic circuit and a steering hydraulic circuit. The lifting hydraulic circuit includes hydraulic fluid tank 81, solenoid valves 82, gear pump 83 and pump motor 84. The lifting hydraulic circuit in hydraulic mechanism 8 provides power for the lifting mechanism 2. Pump motor 84 is connected with gear pump 83, gear pump 83 is connected with hydraulic fluid tank 81 through a conduit, and gear pump 83 is connected with lifting mechanism 2 through a solenoid valve 82. Pump motor 84 drives the gear pump 83. Gear pump 83 takes hydraulic fluid from the tank 81 and controls the lifting mechanism through multiple solenoid valves 82. The steering hydraulic circuit provides steering power for steering mechanism 6. The steering hydraulic circuit includes a hydraulic supply system 86 connected with the hydraulic fluid tank 81. The hydraulic supply system 86 takes hydraulic fluid from the hydraulic fluid tank 81 and connects the conduit to the left and right end of the steering cylinder to drive the steering bridge 61 to rotate and steer the forklift. The steering bridge 61 is driven by the hydraulic fluid pressure of the hydraulic supply system 86. Each part of the lifting cylinder conduit is centered on the left or right side of the middle of the forklift body 1. The hydraulic supply system connected to the steering hydraulic circuit is located on the rear side of the forklift body near the steering mechanism. The hydraulic supply system is connected to the hydraulic fluid tank in the lifting cylinder hydraulic fluid line through the conduit to supply hydraulic fluid. The hydraulic mechanism 8 also includes a fluid tank filling port 85, which is independent of the lifting cylinder conduit and extends to the outside of the forklift vehicle, facilitating the filling through the fluid tank filling port 85.

The hydraulic supply system 86 is connected with the steering wheel 421 of the control mechanism through an electronic power steering (EPS) motor 64 and EPS controller 65. The EPS motor 64 is installed on the rotating axis of the steering wheel 421, and the steering wheel 421 rotates while driving the EPS motor 64. The EPS motor 64 in this example, for instance is a stepper motor, and the EPS controller 65 is installed on the hydraulic supply system 86. The EPS controller 65 is connected with the hydraulic supply system 86, and the steering mechanism 6. A signal is received by the EPS motor 64, and pressure of the hydraulic fluid is diverted into the left chamber or the right chamber of the steering cylinder according to the signal to control the steering. In this example, the hydraulic pump motor 84 and hydraulic supply system 86 control the lifting mechanism 2 and steering mechanism 6 independently. Compared with a traditional mechanical steering forklift, the pump motor 84 has advantages including, that the pump motor 84 does not need to work constantly, which can effectively reduce energy consumption and noise, and steering wheel 421 and steering mechanism 6 are connected by electric steering, so steering wheel 421 requires less steering effort.

The electronic control mechanism 7 connects the control mechanism 42, the hydraulic mechanism 8, the steering mechanism 6, the driving mechanism 5 and the lifting mechanism 2 to control the starting and stopping of the forklift body, the forward and backward movement, the steering angle and the lifting of the fork. The electronic control mechanism 7 includes a battery box 71 housing a lithium battery and a controller 72. The lithium battery box 71 supplies power for electrical equipment such as electric motors on the forklift. The controller 72 receives signals from signal acquisition devices such as steering potentiometers and controls on the motors of the forklift to perform corresponding actions. In order to simplify the control of the motor, the electronic control mechanism sets up several controllers to control the driving motor 53 in the driving mechanism and the pump motor 84 in the hydraulic system respectively. As seen in FIG. 4, in the mounting position, a plurality of controllers 72 are centrally arranged on the front side of the forklift body 1 and above the driving mechanism 5. In this way, it is convenient to troubleshoot the controllers 72 in the later stage, and it can reduce the distance between the controllers 72 and the respective motors as much as possible, thus shortening the length of the cable 74 between respective controller 72 and motor, keeping the line neat and reducing the cost of the cable.

The lithium battery box 71 in the electronic control mechanism 7 is arranged side-by-side in the middle of the forklift body 1 with the lifting hydraulic circuit in the hydraulic mechanism, and the mounting positions of the two are separated by a separator plate 11. The close mounting of the components on the forklift body 1 reduces the volume of the entire vehicle, and the side of the lifting hydraulic circuit path in the above hydraulic mechanism is arranged on the forklift body 1, and an upper side plate may be opened to expose all of the components in the lifting hydraulic circuit path, which is conducive to troubleshooting.

As shown in FIGS. 1, 2 and 11, the forklift body 1 is equipped with an mounting chamber 12 for installing lithium battery boxes 71, and the left or right side of the mounting chamber 12 may be equipped with a plug-in and pull-out opening for a battery box 71. Being of the plug-in and pull-out type refers to the way in which the battery box 71 moves relative to the forklift body 1 in the horizontal direction and is loaded into or removed from the mounting chamber 12 of the forklift body 1. Because of the heavy weight of the battery box itself, in order to push the battery box into the mounting chamber 12 or remove the battery box from the mounting chamber 12, a sliding guide device is installed between the battery box 71 and the mounting chamber 12. The sliding guide device of the example embodiment includes a plurality of rollers 121 arranged at the bottom of the mounting chamber, which are distributed along the moving route of the battery box relative to the mounting chamber 12.

During the process of loading or removing the battery box 71, the bottom of the battery box 71 contacts a rolling plane of the rollers 121 to reduce the friction between the battery box 71 and the mounting chamber. In addition, the mounting chamber is provided with a guide rail for the battery box 71. After the battery box 71 is loaded into the mounting chamber 12, on the one hand, the mechanical connection between the lithium battery box 71 and the forklift body 1 is realized by a locking mechanism, on the other hand, the circuit connection between the battery box and the electronic control mechanism 7 is realized by a plug-in device 73.

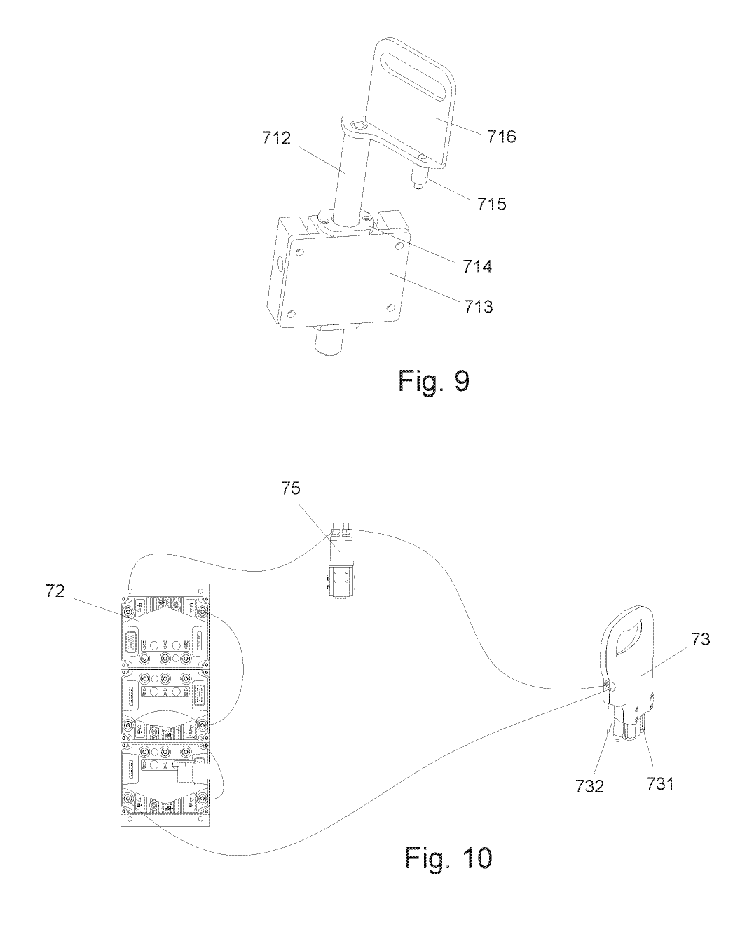

As shown in FIGS. 8, 9, 11 and 12, the locking mechanism in the present embodiment includes a socket 713 on the battery box and a slot 122 on the forklift body 1 for receiving an inserted locking bolt 712. The socket 713 is arranged in the battery box 71, so the locking bolt 712 is connected to the battery box 71 through the socket 713. The upper end of the locking bolt 712 is always exposed from the upper end of the battery box 71, and the lower end of the battery box is provided with a locking bolt 712 for inserting into the slot 122. The slot 122 is located at the bottom of the mounting chamber on the forklift body 1. After the battery box is fully loaded into the mounting chamber 12, the locking bolt 712 is aligned with the slot 122. The locking bolt 712 may slide up and down relative to the socket 713 to insert the locking bolt 712 into the slot 122 or to remove the locking bolt 712 from the slot 122, thus realizing the mechanical locking between the battery box 71 and the forklift body 1. As a preferred choice, the socket 713 is provided with a copper sleeve 714, and the locking bolt 712 is inserted in the copper sleeve 714. The locking mechanism also includes a positioning component that keeps the locking bolt 712 in or out of the slot 122. The positioning component in this embodiment includes a positioning post 715 and a positioning slot arranged on the battery box 71. The locking bolt 712 may rotate around its axis, and the positioning post 715 rotates with the locking bolt 712. The positioning slot matched with the positioning post 715 is located on the rotating path of the positioning post 715. Before the positioning post 715 is inserted into the positioning slot in the battery box 71, the locking bolt 712 is lifted to keep it out of the slot 122 due to the limitation of the upper end face of the battery box 71. The positioning post 715 rotates to the positioning slot in the battery box 71 and the positioning post 715 is pushed downward into the slot in the battery box 71. The locking bolt 712 is inserted into the slot 122 at this time. The interference fit between the positioning post 715 and the positioning slot prevents the positioning post 715 from coming out of the positioning groove due to the shaking of the forklift during operation, thus ensuring the positioning of the battery box by the locking bolt 712. In order to facilitate the operation of the locking bolt 712, it is preferable to fix a handle 716 which drives the action of the locking bolt 712 at the upper end of the locking bolt 712, and the positioning post 715 is also fixed on the handle 716.

As shown in FIG. 8, the body of the battery box 71 is provided with an external power supply socket, which is fixed on the battery box. The power supply socket and the power line of the lithium battery cell in the battery box are all located in the battery box 71. As shown in FIG. 10, the positive and negative poles of the controller 72 of the electric control mechanism of the forklift are connected in series with each other, the controller 72 is connected with the contactor power switch 75 in series, and there is an electric interface on the forklift body 1. At least there are positive and negative pole contacts in the electrical interface, which are connected in series with the controller 72 and the contactor power switch. The position of the electric interface is fixed on the forklift body 1, and the connection lines between the electric interface, the controller 72 and the contactor power switch 75 are all located in the forklift body 1.

The plug-in device 73 fits in a forklift body socket. The plug-in device 73 is equipped with power supply contacts 731 and electric control contacts 732, which mate to power supply contacts and electric control contacts in a socket on the battery box 71. The power supply contacts 731 and electric control contacts 732 are conductively connected inside the plug-in device 73, and the insertion direction of plug-in of power supply contacts 731 and the electric control contacts 732 is the same. Because the battery box 71 is located in the forklift body 1, there are up and down dislocations or front and back dislocations between the power supply socket on the battery box 71 and the electrical interface on the forklift body 1 in the insertion direction of the plug-in device 73, and there are up and down dislocations or front and back dislocations between the corresponding electric control contacts 732 and the power supply contacts 731 in the insertion direction of the plug-in device 73, which is configured with a handle 716. The series connection of power supply contacts 731 and electric control contacts 732 forms a circuit between the battery box 71 and the controller 72, as well as the contactor power switch 75. The contactor power switch 75 controls the battery box 71 to supply power for the electric control mechanism of the forklift body 1.

The circuit connection between the battery box 71 and the controller 72 may be realized by setting a plug-in device 73 at one time, and a contactor power switch 75 is installed in the circuit to control the circuit opening and closing through the contactor power switch 75.

Because the cockpit position on the forklift body 1 is high, at least one step is needed to be set up so that the forklift driver can step up into the cockpit 4. As a preferred choice, step 711 is formed in the battery box 71 of the present embodiment. This advantageously results in no additional step being needed and keeps the structure simple.

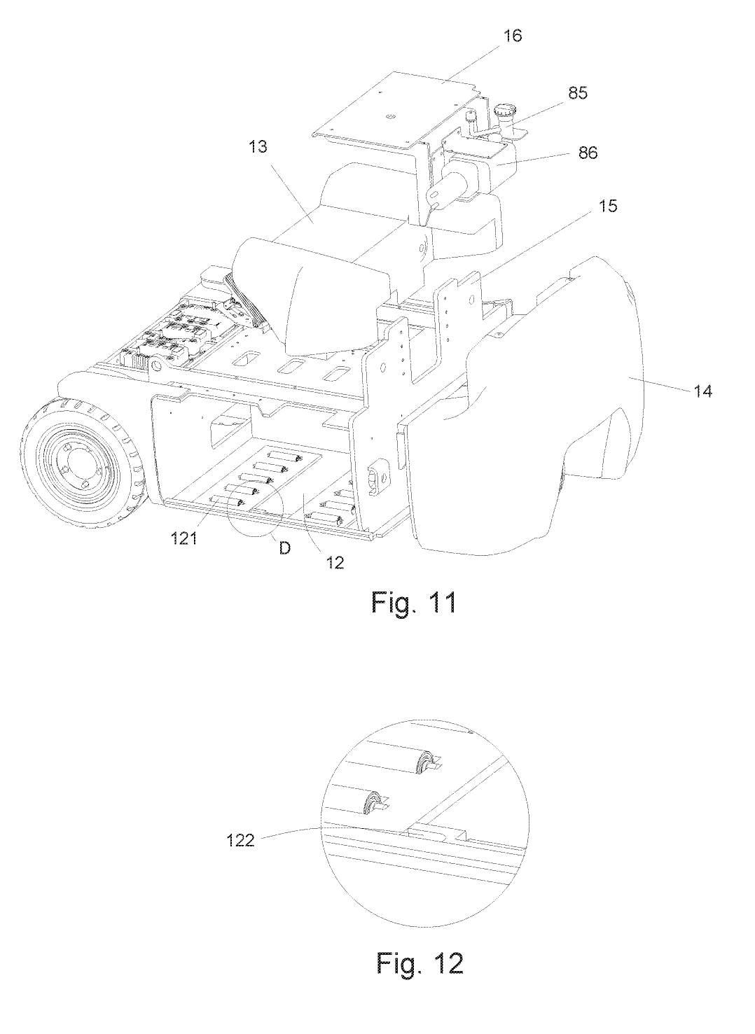

In the forklift in the present embodiment, lithium batteries are used instead of traditional lead-acid batteries, and the lithium batteries are arranged on the forklift body 1 according to the above-described structure. The seat 41 is connected to a rear panel 15 of the forklift body 1 through a seat bracket 16. Because of the high height of the seat 41 atop the seat bracket 16, the mounting space between a lower seat portion and the upper end of the battery mounting chamber is larger than for prior art forklifts. Therefore, as shown in FIG. 11, the counterweight block may be divided into upper counterweight 13 and lower counterweight 14 in the present embodiment. The upper counterweight 13 and lower counterweight 14 are integral structures, respectively. The upper counterweight 13 is arranged in the mounting space from the upper end of the forklift body 1 to the lower part of the seat 41, and the upper counterweight 13 is fixed on the front side of the rear panel 15 of the forklift body 1. The lower counterweight 14 is fixed on the rear side of the rear panel 15 of the forklift body 1, and the lower counterweight 14 is provided with a gap for the steering mechanism 6 to be accessible. The example embodiment divides the typical counterweight block into two parts, namely, the upper counterweight and the lower counterweight. The upper counterweight makes full use of the mounting space between the operator seat and the forklift body 1, making the structure of the vehicle compact. The upper counterweight and the lower counterweight are both located in the rear half of the forklift, thus helping to balance the weight of the vehicle as a whole. The upper and lower counterweights are directly installed on the forklift body 1 as part of the structure, and their shape matches the overall shape of the forklift. On the one hand, the overall structure of the forklift is simple and stylish, and at the same time, the left and right sides of the upper counterweights are equivalent to the width of or protrude further from the outside of the cockpit 4. Thus, no collision bar is needed on the outside of the cockpit seat 41, because the upper counterweight 13 is similar to and protects the outer perimeter of the cockpit 4. The strength of the forklift upper counterweight 13 is very high, and an improved anti-collision effect can be achieved by the addition and location of the counterweight, while reducing the width of the forklift.

It is preferable that the hydraulic supply system 86 of the hydraulic mechanism 8 in the present embodiment is fixed at the back of the seat support 16, so that the distance between the hydraulic supply system 86 and the steering mechanism 6 is small, which is beneficial to the neatness of the hydraulic conduit on the forklift. Also, the hydraulic fluid tank filling port 85 in the hydraulic mechanism is located at the back of the rear panel 15. The fluid tank filling port 85 is connected to the fluid tank through the conduit. The fluid tank filling port 85 is exposed at the outside of the forklift body 1, which is convenient for use in filling fluid tank. In the present embodiment, in order to expose the fuel tank filling opening to the outside of the vehicle, a gap for accommodating the fluid tank filling port 85 may be arranged on the lower counterweight 14.

It should be noted that the above embodiments are only representative examples of the forklift of the present disclosure which may have many different configurations. Any equivalent to or modification of the above embodiments according to the essence of the disclosure shall be considered to be within the scope of the disclosure.

1. A forklift having an integrated battery box, comprising:
a forklift body including a mounting chamber having an opening configured to receive a battery box via plug-in and pull-out of the battery box on a left or right side of the mounting chamber,
the battery box enclosing a lithium battery;
a mechanical connection between the battery box and the forklift body via a locking mechanism that is moved to a locking position after the battery box is loaded into the mounting chamber;
a circuit connection between the battery box and an electric control mechanism of the forklift by insertion of a plug-in device into a socket in the battery box; and
further comprising power supply contacts and electric control contacts, with the power supply contacts and the electric control contacts being located in the socket in battery box.

2. The integrated battery box for a forklift in accordance with claim 1, wherein the battery box has a body that is provided with an external power supply socket, with the position of the power supply socket being fixed on the battery box.

3. The integrated battery box for a forklift in accordance with claim 1, wherein an electric interface is fixed on the forklift body, and at least positive and negative contacts are arranged in the electric interface, which are connected in series with the electric control mechanism of the forklift.

4. The integrated battery box for a forklift in accordance with claim 1, wherein a sliding guide device is arranged between the battery box and the mounting chamber.

5. The integrated battery box for a forklift in accordance with claim 4, wherein the sliding guide device further comprises a plurality of rollers arranged at a bottom of the mounting chamber.

6. The integrated battery box for a forklift in accordance with claim 5, wherein the plurality of rollers are distributed on the moving route of the battery box relative to the mounting chamber and when the battery box is loaded into the mounting chamber the bottom of the battery box contacts a rolling plane of the rollers.

7. The integrated battery box for a forklift in accordance with claim 1, wherein a locking mechanism includes a locking bolt arranged on the battery box and a corresponding slot arranged on the forklift body for inserting the locking bolt, and wherein the locking bolt slides up and down relative to the slot to lock or release the locking bolt from the slot.

8. The integrated battery box for a forklift in accordance with claim 7, wherein the locking mechanism also includes a positioning component that keeps the locking bolt in the slot or out of the slot.

9. The integrated battery box for a forklift in accordance with claim 8, wherein the positioning component includes a positioning post connected to the locking bolt and a positioning slot is arranged on the battery box and receives the positioning, post after the locking bolt has been :raised and removed from a slot in the forklift body.

10. The integrated battery box for a forklift in accordance with claim 1, wherein a step is defined in the batten box.
